(19) United States
(12) Patent Application Publication
(10) Pub. No.: US 2025/0228721 A1
(43) Pub. Date: Jul. 17, 2025

(54) MATTRESS FOR PATIENT SUPPORT APPARATUS

(71) Applicant: Hill-Rom Services, Inc., Batesville, IN (US)

(72) Inventor: Douglas E. Borgman, Brookville, IN (US)

(21) Appl. No.: 19/008,273

(22) Filed: Jan. 2, 2025

Related U.S. Application Data
(60) Provisional application No. 63/621,448, filed on Jan. 16, 2024.

(51) Int. Cl. A61G 7/015

(52) U.S. Cl. CPC A61G 7/015

(57) ABSTRACT

A mattress for a patient support apparatus is disclosed. The mattress includes a body extending between a proximal end and a distal end. The proximal end has appendages that extend from the body. The mattress further includes a liner positioned between the appendages. The liner reduces a shear force between the appendages.

### CROSS REFERENCE TO RELATED APPLICATION

This application claims the benefit of and priority to U.S. Provisional Patent Application No. 63/621,448, filed on 16 Jan. 2024, the disclosure of which is hereby incorporated by reference in its entirety.

### BACKGROUND

A patient support apparatus such as a hospital bed or other type of bed typically includes a mattress supported on a frame having advanced articulation to allow for customized adjustment and positioning of a patient. Relative movement of the components of the frame cause the mattress to exert a shear force on the body of a patient such as on a posterior portion of the body when the patient is laying supine on the mattress. The shear force can cause the patient to experience discomfort and, in some cases, even pain.

### SUMMARY

In general terms, the present disclosure relates to a mattress for a patient support apparatus. In one possible configuration, the mattress reduces a shear force exerted on a patient by an upper surface of the mattress by having a liner with a low coefficient of friction inserted between appendages that extend from a body of the mattress. Various aspects are described in this disclosure, which include, but are not limited to, the following aspects.

One aspect relates to a mattress for a patient support apparatus, the mattress comprising: a body extending between a proximal end and a distal end, the proximal end having appendages extending from the body; and a liner positioned between the appendages, the liner reducing a shear force between the appendages.

Another aspect relates to a method of manufacturing a mattress for a patient support apparatus, the method comprising: forming a body that extends between a proximal end and a distal end, the proximal end having appendages extending from the body; and inserting a liner between the appendages on the proximal end of the body, the liner reducing a shear force between the appendages.

Another aspect relates to a patient support apparatus comprising: a base frame; a lift system supported by the base frame; an upper frame connected to the lift system such that the lift system is operable to move the upper frame vertically relative to the base frame, the upper frame including one or more decks articulated relative to a load frame; and a mattress supported on the load frame, the mattress including: a body extending between a proximal end and a distal end, the proximal end having appendages extending from the body; and a liner positioned between the appendages, the liner reducing a shear force between the appendages.

A variety of additional aspects will be set forth in the description that follows. The aspects can relate to individual features and to combination of features. It is to be understood that both the foregoing general description and the following detailed description are exemplary and explanatory only and are not restrictive of the broad inventive concepts upon which the embodiments disclosed herein are based.

### DESCRIPTION OF THE FIGURES

The following drawing figures, which form a part of this application, are illustrative of the described technology and are not meant to limit the scope of the disclosure in any manner.

FIG. 1 illustrates an isometric view of an example of a patient support apparatus.

FIG. 2 illustrates a side view of an example of the mattress of the patient support apparatus of FIG. 1, the mattress is shown in a flat position.

FIG. 3 illustrates another side view of the mattress of FIG. 2 shown in a tilt position.

FIG. 4 illustrates a cross-sectional view of another example of the mattress of the patient support apparatus of FIG. 1.

FIG. 5 illustrates a cross-sectional view of another example of the mattress of the patient support apparatus of FIG. 1.

FIG. 6 schematically illustrates an example of a method of manufacturing a mattress for the patient support apparatus of FIG. 1.

### DETAILED DESCRIPTION

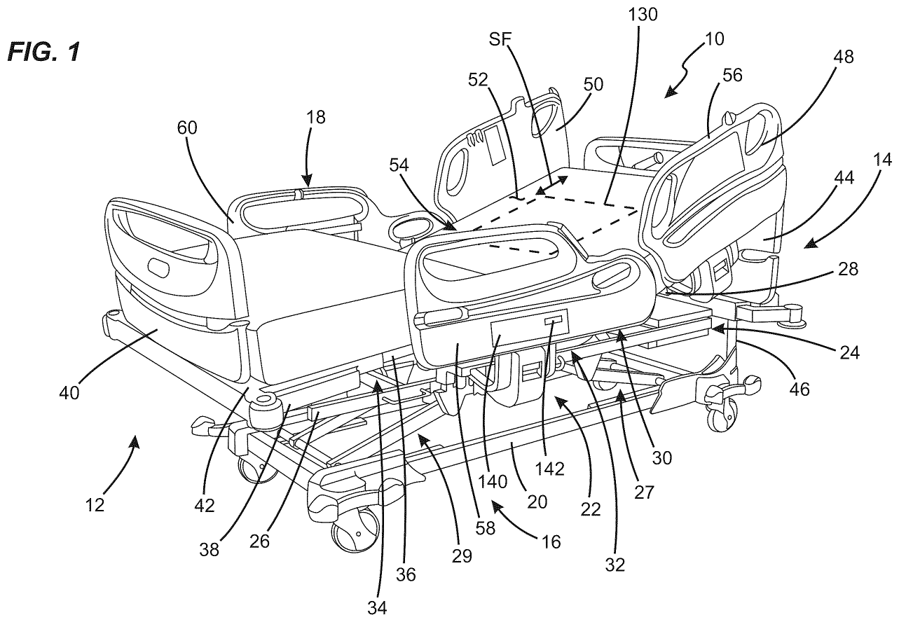

FIG. 1 illustrates an isometric view of an example of a patient support apparatus 10. In FIG. 1, the patient support apparatus 10 is illustrated as a hospital bed. In alternative examples, it is contemplated that the patient support apparatus can take the form of other types of beds, stretchers, patient tables, and the like.

The view shown in FIG. 1 is generally taken from a position that is oriented at the left side, foot end of the patient support apparatus 10. For purposes of orientation, the discussion of the patient support apparatus 10 will be based on the orientation of a patient supported on the patient support apparatus 10 in a supine position. Thus, the foot end 12 of the patient support apparatus 10 refers to the end nearest the patient's feet when the patient is supported on the patient support apparatus 10 in the supine position. The patient support apparatus 10 has a head end 14 opposite the foot end 12. A left side 16 refers to the patient's left when the patient is lying in the patient support apparatus 10 in a supine position. The right side 18 refers to the patient's right when the patient is lying in the patient support apparatus 10 in a supine position.

As described herein, the longitudinal length of the patient support apparatus 10 refers to a direction that generally extends between the head end 14 and the foot end 12 of the patient support apparatus. As further described herein, the lateral width of the patient support apparatus 10 refers to a direction that generally extends between the left side 16 and the right side 18.

The patient support apparatus 10 includes a base frame 20, which supports a lift system 22. The lift system 22 engages the base frame 20 and an upper frame 24 such that the lift system 22 moves the upper frame 24 vertically relative to the base frame 20. The lift system 22 includes a head end linkage 27 and a foot end linkage 29. The head end linkage 27 and the foot end linkage 29 are each independently operable. For example, each of the head end linkage 27 and the foot end linkage 29 may be operated to cause the patient support apparatus 10 to move into a tilt position which is when the head end 14 of the upper frame 24 is positioned higher than the foot end 12 of the upper frame 24. The patient support apparatus 10 may also be moved to a reverse tilt position with the foot end 12 positioned higher than the head end 14.

The upper frame 24 supports a load frame 26. The load frame 26 supports a head deck 28 which is movable relative to the load frame 26. The load frame 26 also supports an articulated seat deck 30. The articulated seat deck 30 is movable relative to the load frame 26 and a fixed seat deck 32. Additionally, a foot deck 34 is supported from the load frame 26 and is articulated and moveable relative to the load frame 26.

In the example of FIG. 1, the foot deck 34 provides for powered pivoting of the foot deck 34 and manual extension and retraction of the foot deck 34 to vary a longitudinal length of the foot deck 34. In other examples, powered pivoting of the foot deck 34 may be omitted and the movement may be caused manually, or follow movement of the seat deck 30. In some examples, extension and retraction of the foot deck 34 may be powered by an actuator.

The foot deck 34 includes a first portion 36 and a second portion 38, which moves relative to the first portion 36 to vary the size of the foot deck 34. The second portion 38 moves generally longitudinally relative to the first portion 36 to vary the longitudinal length of the foot deck 34, and thereby an overall longitudinal length of the patient support apparatus 10.

A foot panel 40 is supported from the second portion 38 and extends vertically from an upper surface 42 of the second portion 38 to form a barrier at the foot end 12 of the patient support apparatus 10. A head panel 44 is positioned on an upright structure 46 of the base frame 20 and extends vertically to form a barrier at the head end 14 of the patient support apparatus 10.

A left head side rail 48 is supported from the head deck 28 and is moveable between a raised position (shown in FIG. 1) and a lowered position. A right head side rail 50 is also moveable between the raised position of FIG. 1 and the lowered position. As shown in FIG. 1, in the raised position, the left head and right head side rails 48, 50 extend above an upper surface 52 of a mattress 54 of the patient support apparatus 10 when the left head and the right head side rails 48, 50 are in a raised position. In the lowered position, an upper edge 56 of the left head side rail 48 is below the upper surface 52. The left head side rail 48 and the right head side rail 50 are also movable to a position between the raised position and the lowered position.

The patient support apparatus 10 also includes a left foot side rail 58 and a right foot side rail 60, each of which is supported directly from the load frame 26. Each of the side rails 48, 50, 58, and 60 are operable to be lowered to a position below the upper surface 52 of the mattress 54. It should be appreciated that in some examples, the left foot side rail 58 and the right foot side rail 60 are movable to a position between the raised position and the lowered position. It should be noted that when the head deck 28 is moved, the left head and right head side rails 48, 50 move with the head deck 28 so that they maintain their relative position to the patient. This is because the left head and right head side rails 48, 50 are supported by the head deck 28.

In the illustrative example shown in FIG. 1, a weigh scale 130 is positioned between the mattress 54 and the upper frame 24. In some examples, the weigh scale 130 may be positioned within the mattress 54. The weigh scale 130 measures a weight of a patient on the mattress 54. The weigh scale 130 may also measure a distribution of the patient's weight.

A control system 140 may be embedded in one of the side rails 48, 50, 58, and 60. A graphical user interface 142 is electronically coupled to the control system 140 such that a user, such as a caregiver or a patient, can operate the patient support apparatus 10. The graphical user interface 142 may include buttons or icons configured to control movement of the various sections of the patient support apparatus 10. The graphical user interface 142 transmits a signal to the control system 140 indicative of the desired movement, and the control system 140 operates the various motors and actuators to move the sections of the patient support apparatus 10. The graphical user interface 142 may also display outputs from various sensors in the patient support apparatus 10, such as a patient weight measured by the weigh scale 130, or vital signs measured by one or more sensors positioned under the mattress 54.

As shown in FIG. 1, the mattress 54 is supported on the load frame 26. The mattress 54 is configured to conform to the shape of the load frame 26 such as when the head deck 28, the articulated seat deck 30, and the foot deck 34 are tilted relative to one another. When the mattress 54 is conforming to the shape of the load frame 26, such as when the head deck 28, the articulated seat deck 30, and the foot deck 34 are moving or tilting relative to one another, a shear force SF is produced between the upper surface 52 of the mattress 54 and a patient when laying in the supine position on the patient support apparatus 10. The shear force SF is parallel to the upper surface 52 of the mattress 54. The shear force SF is directed toward the head end 14 of the patient support apparatus 10 such as when the head deck 28 is inclined relative to the seat decks 30, 32. The shear force SF can be uncomfortable and even painful for some patients.

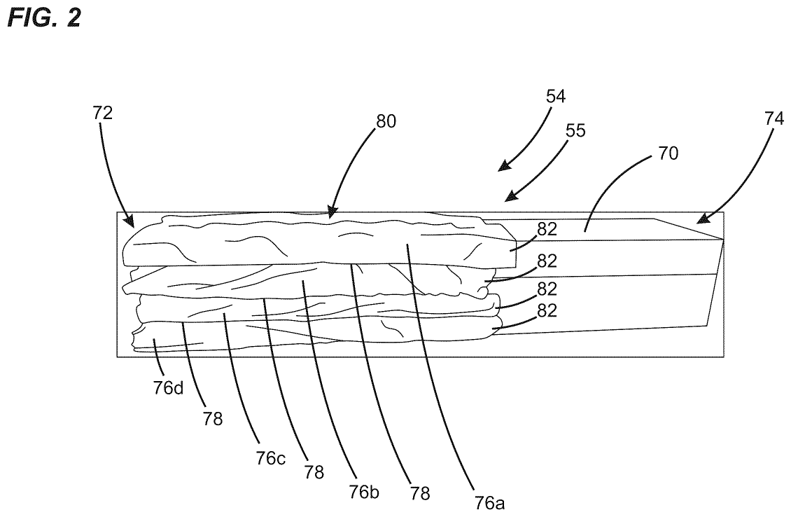

FIG. 2 is a side view of an example of the mattress 54 of the patient support apparatus 10. In the example shown in FIG. 2, the mattress 54 is shown in a flat position 55, such as when the head deck 28, the seat decks 30, 32, and the foot deck 34 are positioned flat and parallel to the load frame 26 of the patient support apparatus 10.

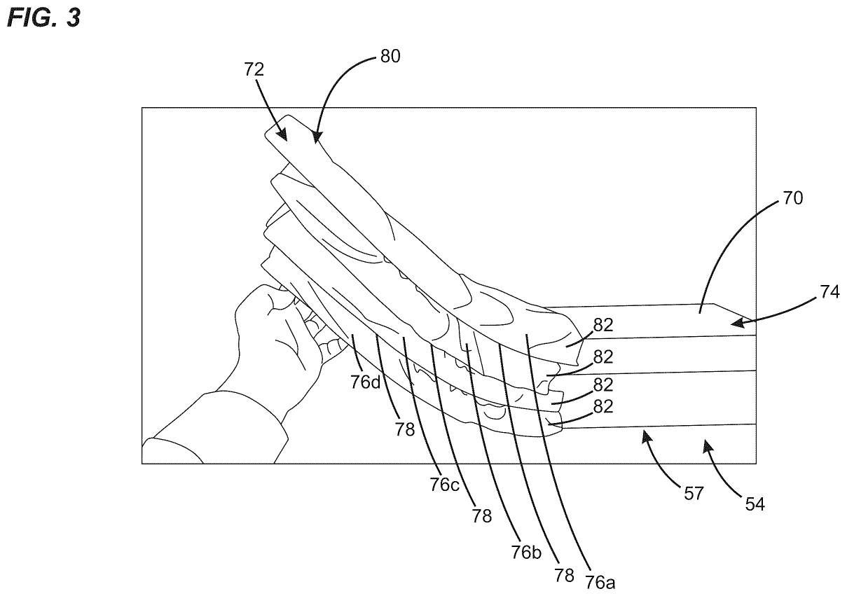

FIG. 3 is another side view of the mattress 54 shown in a tilt position 57, such as when the head deck 28 is tilted or inclined relative to the seat decks 30, 32 and the foot deck 34 of the load frame 26. Referring now to FIGS. 2 and 3, the mattress 54 includes a body 70 extending between a proximal end 72 and a distal end 74. The body 70 is made of a material to provide cushioning for the patient's body. In some examples, the body 70 of the mattress 54 is made from a foam material. As shown in FIGS. 2 and 3, the proximal end 72 of the body 70 has grooves 78 forming a plurality of appendages 76 on the body 70 at the proximal end.

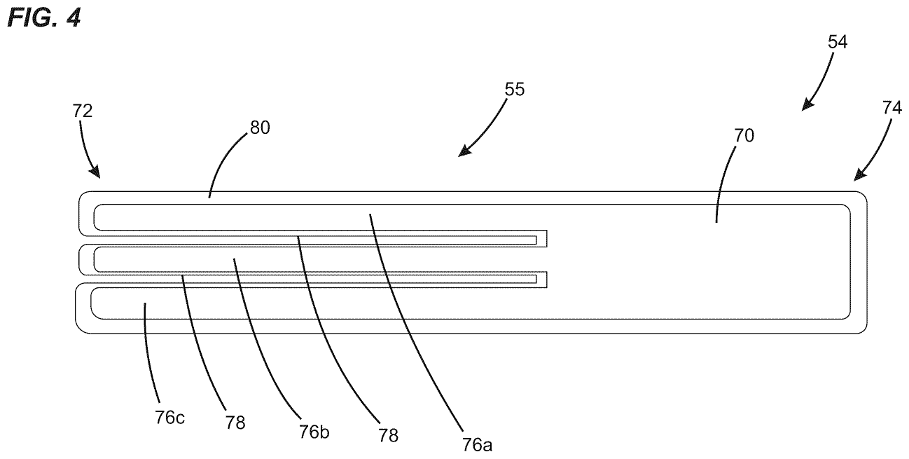

In the example shown in FIGS. 2 and 3, the body 70 includes three grooves forming four appendages 76a-76d at the proximal end 72. A first appendage 76a is configured to abut the patient's body, a second appendage 76b is positioned below the first appendage 76a, a third appendage is position below the second appendage 76b, and a fourth appendage is positioned below the third appendage 76c and is configured to abut the load frame 26. It is contemplated the number of grooves and appendages on the body 70 may vary such that there can be more than three grooves or fewer than three grooves, and that there can be more than four appendages or fewer than four appendages. For example, the body 70 can include a single groove that forms two appendages. Alternatively, the body 70 can include two grooves that form three appendages such as in the example shown in FIG. 4, which will be described in more detail further below.

The mattress 54 includes a liner 80 that is positioned inside at least one of the grooves 78 between two appendages of the plurality of appendages 76. As described in more detail, the liner 80 reduces the shear force SF between the appendages, causing a reduction in the shear force SF exerted by the upper surface 52 of the mattress 54 on the skin surfaces of the patient when the patient is laying on the patient support apparatus 10 and the mattress 54 is conforming to the movements of the head deck 28, the articulated seat deck 30, and the foot deck 34.

In the example shown in FIGS. 2 and 3, the liner 80 includes a plurality of sleeves 82. Each sleeve 82 fits over an appendage 76 on the proximal end 72 of the body 70. For example, during manufacture of the mattress 54, each sleeve 82 slides onto an appendage 76 such that the sleeve 82 encases or at least partially surrounds the appendage 76.

The sleeves 82 are made of a material having a low coefficient of friction such that the sleeves 82 are slippery. For example, the sleeves 82 can be made of a ripstop fabric such as nylon material, or can be made from a polyurethane film. The low coefficient of friction of the sleeves 82 causes the appendages 76 to slide against one another such as when the mattress 54 is moved from the flat position 55 to the tilt position 57 due to movement of the articulated decks of the load frame 26. The sliding between the appendages 76 reduces the shear force SF that acts on the patient because shearing occurs internally inside the mattress 54 such that the patient feels less shear force SF from the upper surface 52 of the mattress 54 acting on their body.

As further shown in FIGS. 2 and 3, a sleeve 82 can slide onto the fourth appendage 76d that abuts the load frame 26 of the patient support apparatus 10. In such examples, adding the sleeve 82, which has a low coefficient of friction, between the mattress 54 and the load frame 26 can further reduce the shear force SF that acts on the patient by allowing the mattress 54 to slide relative to the load frame 26 of the patient support apparatus 10.

FIG. 4 illustrates a cross-sectional view of another example of the mattress 54 of the patient support apparatus 10. In this example, the liner 80 is shaped to encase or at least partially surround the body 70 of the mattress 54. Further, the liner 80 includes portions that fit inside the grooves 78 between the plurality of appendages 76 on the proximal end 72 of the body 70.

In the example shown in FIG. 4, the body 70 of the mattress 54 is made from a foam material (like in the example described above with respect to FIGS. 2 and 3). Also, the liner 80 is made of a material having a low coefficient of friction such as a ripstop fabric made from nylon material, a polyurethane film, or other type of slippery material.

As further shown in FIG. 4, by encasing or at least partially surrounding the body 70 of the mattress 54 with the liner 80, the liner 80 is positioned between the mattress 54 and the load frame 26. This can further reduce the shear force SF that acts on the patient.

As shown in FIG. 4, the body 70 includes the appendages 76 and the grooves 78 on the proximal end 72 to provide layers within the mattress 54, which is solid. The layers formed by the appendages 76 and the grooves 78 allow a material such as the liner 80 to be placed in between the layers to facilitate sliding of the layers relative to each other. This movement inside the mattress 54 lessens shear and fiction forces exerted on a patient laying on the surface of the mattress. The mattress 54 remains solid and intact as the layers slide relative to each other such that the layers are kept together, which prevents the layers formed by the appendages 76 from becoming loose inside a cover that encases the mattress 54 such as the liner 80.

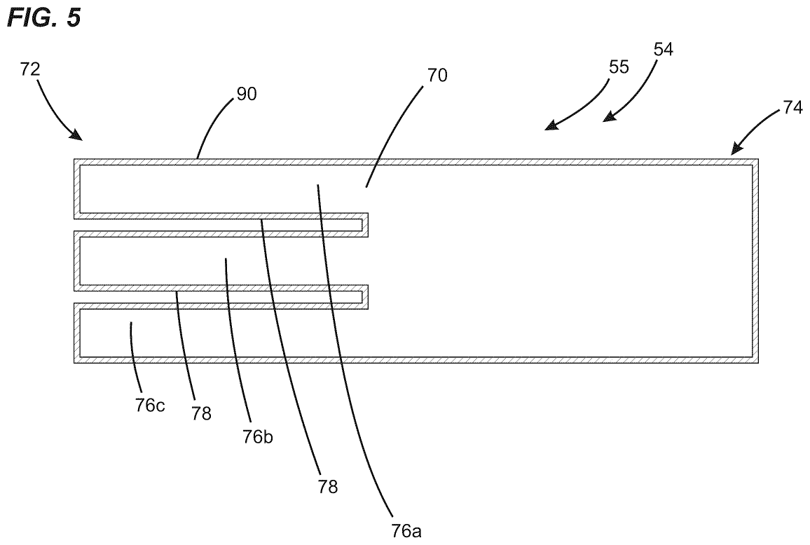

FIG. 5 illustrates a cross-sectional view of another example of the mattress 54 of the patient support apparatus 10. In this illustrative example, the body 70 of the mattress 54 includes an external layer 90 having a low coefficient of friction. The external layer 90 can include a coating that is applied to the body 70 after the body is formed into the shape having the appendages 76 separated by the grooves 78. Alternatively, the external layer 90 can be integrated with the body 70 through extrusion or other techniques.

In this example, the mattress 54 does not include separate sleeves that encase or at least partially surround the appendages 76 of the body 70 as shown in the example of FIGS. 2 and 3 or a separate liner that encases or at least partially surrounds the body 70 of the mattress 54 as shown in the example of FIG. 4. Instead, in this example, the body 70 of the mattress 54 (including the appendages 76) is made slippery to itself, which reduces the shear force exerted by the mattress 54 on the body of the patient, as described in the examples above.

By positioning material having a low coefficient of friction in the grooves 78 between the appendages 76, whether the material is the liner 80 and/or sleeves 82, or a coating or an external layer surrounding the appendages 76, such material is not noticeable from outside of the mattress 54 and does not change the overall shape or size of the mattress 54. Additionally, such features allow the mattress to work regardless of the frame it is placed on such that the mattress 54 can be made agnostic to a variety of different types of patient support apparatuses.

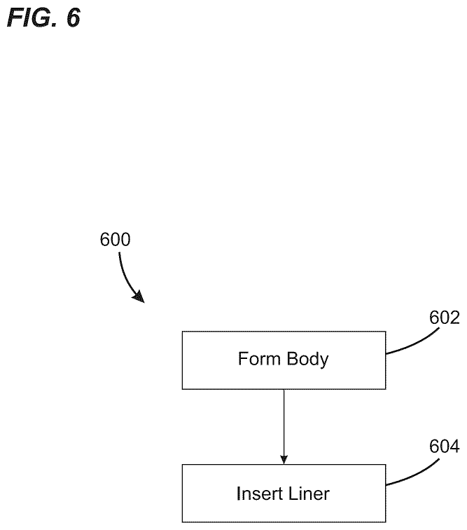

FIG. 6 schematically illustrates an example of a method 600 of manufacturing the mattress 54 for the patient support apparatus 10. The method 600 includes an operation 602 of forming the body 70 that extends between the proximal end 72 and the distal end 74. Operation 602 can include molding a foam material into the shape of the mattress shown in the examples of FIGS. 2-4. For example, operation 602 can include molding the foam material into a shape that includes one or more groove 78 between the appendages 76 on the proximal end 72 of the body 70. Alternatively, operation 602 can include acquiring a solid block of foam material, and cutting one or more grooves 78 into the solid block of foam material to form the appendages 76.

The method 600 further includes an operation 604 of inserting a liner 80 into a groove 78 between appendages 76 on the proximal end 72 of the body 70. As described above, the liner 80 is made of a material having a low coefficient of friction such as a ripstop fabric made from nylon material, a polyurethane film, or other type of slippery material. The liner 80 reduces the shear force SF between the appendages 76, and thereby reduces the shear force SF exerted by the upper surface 52 of the mattress 54 acting on the skin surface of the patient.

Operation 604 can include fitting the liner 80 over at least one of the appendages 76 of the plurality of appendages. For example, operation 604 can include sliding a sleeve 82 over the appendage 76 as shown in the example of FIGS. 2 and 3. Alternatively, operation 604 can include fitting the liner 80 to encase or surround the body 70 of the mattress 54 with one or more portions of the liner 80 fitting between the appendages 76, as shown in the example of FIG. 4.

In further alternative examples, such as in the example shown in FIG. 5, operation 604 can include applying an external layer having a low coefficient of friction. For example, operation 604 can include applying a coating having a low coefficient of friction on the body 70.

By forming the body 70 to include the appendages 76 and the grooves 78 on the proximal end 72, the method 600 provides layers within a solid mattress 54 that allows a material such as the liner 80 to be placed in between the layers to facilitate sliding of the layers relative to each other to lessen shear and fiction forces exerted on a patient laying on the surface of the mattress, while at the same time having the mattress 54 remain solid and intact as the layers slide relative to each other such that the layers are kept together, which prevents the layers from becoming loose inside a cover that encases the mattress 54 such as the liner 80.

The various embodiments described above are provided by way of illustration only and should not be construed to be limiting in any way. Various modifications can be made to the embodiments described above without departing from the true spirit and scope of the disclosure.

What is claimed is:

1. A mattress for a patient support apparatus, the mattress comprising:
a body extending between a proximal end and a distal end, the proximal end having appendages extending from the body; and
a liner positioned between the appendages, the liner reducing a shear force between the appendages.

2. The mattress of claim 1, wherein the liner includes a sleeve that fits over at least one of the appendages.

3. The mattress of claim 1, wherein the body includes a plurality of grooves between a plurality of appendages at the proximal end of the body.

4. The mattress of claim 3, wherein the liner includes a plurality of sleeves fitting over each appendage of the plurality of appendages.

5. The mattress of claim 1, wherein the liner is shaped to encase the body and to have a portion that fits between the appendages.

6. The mattress of claim 1, wherein the body is made of a foam material.

7. The mattress of claim 1, wherein the liner is made from a ripstop fabric of nylon material.

8. The mattress of claim 1, wherein the liner is made of a polyurethane film.

9. A method of manufacturing a mattress for a patient support apparatus, the method comprising:
forming a body that extends between a proximal end and a distal end, the proximal end having appendages extending from the body; and
inserting a liner between the appendages on the proximal end of the body, the liner reducing a shear force between the appendages.

10. The method of claim 9, further comprising:
cutting at least one groove into the proximal end of the body to form the appendages.

11. The method of claim 9, wherein forming the body includes molding a shape that includes at least one groove between the appendages on the proximal end of the body.

12. The method of claim 9, wherein the body is made of a foam material.

13. The method of claim 9, further comprising:
fitting the liner over at least one appendage.

14. The method of claim 9, further comprising:
fitting the liner to surround the body with one or more portions of the liner fitting between the appendages.

15. The method of claim 9, wherein the liner is made of a nylon material or a polyurethane film.

16. A patient support apparatus comprising:
a base frame;
a lift system supported by the base frame;
an upper frame connected to the lift system such that the lift system is operable to move the upper frame vertically relative to the base frame, the upper frame including one or more decks articulated relative to a load frame; and
a mattress supported on the load frame, the mattress including:
a body extending between a proximal end and a distal end, the proximal end having appendages extending from the body; and
a liner positioned between the appendages, the liner reducing a shear force between the appendages.

17. The patient support apparatus of claim 16, wherein the body includes at least one groove between the appendages.

18. The patient support apparatus of claim 16, wherein the liner includes a sleeve fitting over at least one of the appendages.

19. The patient support apparatus of claim 16, wherein the liner is shaped to surround the body and to have one or more portions that fit between the appendages.

20. The patient support apparatus of claim 16, wherein the body is made of a foam material, and the liner is made of a nylon material or a polyurethane film.
